(19) United States
(12) Patent Application Publication
(10) Pub. No.: US 2017/0130013 A1
(43) Pub. Date: May 11, 2017

(54) POLYVINYL CHLORIDE-FREE DECORATIVE SURFACE COVERINGS

(71) Applicant: TARKETT GDL, Lentzweiler (LU)

(72) Inventors: Pierre BASTIN, Wiltz (LU); Pascal DI CROCE, Wiltz (LU); Alexandre SICHE, Wiltz (LU); Jean-Yves SIMON, Wiltz (LU)

(21) Appl. No.: 15/321,930

(22) PCT Filed: May 21, 2015
(86) PCT No.: PCT/EP2015/061281

§ 371 Date: Dec. 23, 2016

(30) Foreign Application Priority Data
Jun. 30, 2014 (EP) 14174978.8

(51) Int. Cl. C08J 5/04; B32B 5/02; C08L 31/04; C08L 23/06; C08L 23/08

(52) U.S. Cl. CPC C08J 5/043; C08L 23/06; C08L 23/08; C08L 31/04; B32B 5/022; B32B 5/028; C08J 2323/06; C08J 2331/04; C08J 2323/08; C08J 2451/06; C08L 2205/025; C08L 2205/035; B32B 2451/00

(57) ABSTRACT

PVC-free decorative surface covering comprising a reinforced layer, said layer comprising a carrier impregnated with a PVC-free paste, said paste comprising from 5 to 50% by weight of a PVC-free polymer blend, from 45 to 90% by weight of one or more fillers and from 0.5 to 12% by weight of one or more lubricants. The PVC-free decorative surface coverings are prepared by a calendering process.

### FIELD OF THE INVENTION

The present invention is related to polyvinyl chloride-free decorative floor and wall coverings comprising a carrier impregnated with a PVC-free paste. The invention is further related to a method for the production of said surface coverings.

### STATE OF THE ART

Materials for floor, wall and ceiling coverings should possess a wide variety of properties. Particularly important for materials used for floor coverings are good wear, abrasion, scratch and indentation resistance and good indentation recovery to reduce visible scratches and indentations of furniture and rolling objects, such as office chairs.

Well known floor coverings are based on polyvinyl chloride (PVC). PVC-based materials have many desirable properties, such as good filler acceptance, flexibility and scratch resistance. However, in more recent years attention has been focused on the disadvantages of PVC-based flooring.

Typical PVC surface coverings include a PVC-plastisol. The plastisol typically consists of PVC particles, plasticizer, heavy metal additives and inorganic filler. The surface covering is formed in a spreading process by laying-down the plastisol on a backing layer and subsequently fusing and gelling said plastisol at temperatures comprised between 130 and 180° C.

The use of heavy metal stabilizers (e.g. dilauryl tin distearate or carboxylates of barium and cadmium, barium and zinc or calcium and zinc) is especially important to avoid degradation of the PVC polymer.

Plasticizers have a tendency to migrate, which results in a gradual deterioration in resiliency and build-up of a sticky residue that can lead to dirt accumulation, and the plasticizers can form pathways in the polymer for dye migration which can render printed patterns less distinct.

The ecological concerns respecting the PVC decorative covering segment pertain to recyclability or energy recovery, volatile organic content levels, and the use of heavy metal stabilizers.

The hydrogen chloride and heavy metal ash from decomposition of the heavy metal stabilizers are undesired consequences from the incineration of scrap associated with manufacturing and installation of PVC-based covering materials.

Consequently, even though PVC offers an excellent mechanical, acoustic and heat insulation compromise in its application to floor coverings, the manufacturers of these coverings have been looking for a substitute for it, providing an answer to the following three points of concern:
releasing no toxic gas when burnt, such as chlorine, hydrochloric acid, sulfur dioxide or nitrogen oxides;
having properties, especially mechanical properties and fire resistance, of the same order as those obtained today with PVC ;
being capable of processing or fabrication on existing equipment, especially by extrusion, calendering, and the like.

In recent years, olefin based decorative surface covering materials have become popular and already have been subject of a considerable number of patents.

PVC-free floor and wall coverings for example are disclosed in EP 0257796 (B1), EP 0742098 (B1), U.S. Pat. No. 4,379,190, U.S. Pat. No. 4,403,007, U.S. Pat. No. 4,438,228, U.S. Pat. No. 5,409,986, U.S. Pat. No. 6,214,924, U.S. Pat. No. 6,187,424, US 2011/0305886, JP 2004168860, JP 2002276141, JPH 07125145, JPH 06128402, JP 2000063732, JPH 1148416, JP 2000045187, JPH 0932258, JPS 6092342 and JPH 09302903.

US 2011/0223387 discloses a non-PVC type calendered polyolefin plastic sheet, wherein components thereof include:
a) 100 parts of polyolefin resin comprising two resins or more from polyethylene, polypropylene, ethylene-vinyl acetate copolymers, thermoplastic elastomers, thermoplastic polyolefins,
b) 0.1 to 15 parts of lubricants selected from stearic acid, fatty acid ester, fatty acid amide, paraffin hydrocarbons, metal soaps, organic silicones, alone or the mixture thereof,
c) 0.1 to 50 parts of plasticizers selected from non-phthalate plasticizers, polyester polymer plasticizers, processing oils, alone or the mixture thereof,
d) 0.1 to 80 parts of auxiliaries such as modifiers, ultraviolet absorbents, fire retardant agents, fillers, dispersion agents etc. alone or the mixture thereof, and
e) 0 to 15 parts of colorants.

The process to manufacture the polyolefin plastic sheets includes first blending the polyolefin composition and the additives with a mixer, then homogeneously mixing in Banbury mixer and gelling in a roll mill at a temperature controlled in the range of 130 to 200° C., finally calendering with a traditional PVC film process. The compositions as claimed and illustrated in the different examples comprise less than 40% by weight of filler.

Decorative surface coverings may in some cases include a reinforced layer, consisting of an impregnated carrier.

The impregnated carrier gives both strength and dimensional stability to the decorative surface covering.

EP 0775231 (B1) discloses a sheet material for floor covering comprising a polyalkylene resin in intimate admixture with at least one additive comprising a filler, wherein said polyalkylene resin has a relatively narrow molecular weight distribution and a small amount of long chain branching and obtainable by a single site catalyzed polymerization of at least one, linear, branched or cycled alkylene having from 2 to 20 carbon atoms. The polyalkylene is characterized by a Melt Index of from 0.1 to 100 g/10 minute and a density of from 0.86 to 0.97 g.cm⁻³.

The floor covering comprises a backcoat layer, a structural layer and a topcoat layer wherein the structural layer comprises a reinforcing carrier or substrate (e.g. woven or non-woven mesh or fabric, or tissue of more or less thermally stable materials such as glass fiber) impregnated and/or coated with a saturant formula.

U.S. Pat. No. 6,287,706 relates to a solid sheet polymeric floor covering, comprising a plurality of layers including a structural layer comprising a reinforcing carrier or substrate impregnated and/or coated with a saturant formula; a solid backcoat layer; and a clear protective or topcoat layer wherein at least one of said layers comprises a sheet material comprising a polyalkene resin in intimate admixture with at least one additive comprising a filler, wherein said polyalkene resin is a polyalkene resin obtained by a single site catalyzed polymerization of at least one, linear, branched or cyclic, alkene having from 2 to 20 carbon atoms.

US 2008/0206583 discloses a composition for a surface covering or portion thereof comprising:
a) 5 to 45% by weight of at least one first polymer;
b) 0.1 to 20% by weight of at least one second polymer different from the first polymer,
c) 0.1 to 5% by weight of at least one polyolefin having at least one polar group,
d) 0.1 to 5% by weight of at least one tackifier comprising at least one hydrocarbon, wherein the hydrocarbon comprises an aliphatic hydrocarbon, a cycloaliphatic hydrocarbon, an aromatic modified aliphatic hydrocarbon, an aromatic and aliphatic hydrocarbon modified with at least one fatty acid ester or any combination thereof,
e) 0.1 to 5% by weight of at least one dispersion agent comprising at least one ultra-high melt flow polypropylene and/or at least one lubricant, and
f) 50 to 90% by weight of at least one filler,
   wherein the first polymer comprises at least one ethylene propylene copolymer and the second polymer comprises at least one polypropylene homopolymer or wherein the first polymer comprises at least one Ziegler Natta polyolefin and/or the second polymer comprises at least one metallocene polymer.

A laminated surface or floor covering can comprise a backing layer comprising the above composition, a decor layer (or print layer) and at least one wear layer. The surface coverings also optionally may include (an) additional layer(s), such as a glass mat or synthetic film for the purposes of balancing the structure and performance. For example, the additional layer can comprise an olefin blend, a glass mat, a thermoplastic film, or any combination thereof.

When PVC-free floorings, comprising a carrier reinforced layer, are considered, the viscosity of the PVC-free paste is a major problem. If the PVC-free paste is calendered, its high viscous melt shows poor processability.

In order to be able to use PVC-free pastes on conventional calendering equipment, the viscosity of said PVC-free pastes in general is reduced through the addition of high melt flow polymers, for example a high melt flow rate semi-crystalline ethylene-butane-1-copolymer such as disclosed in EP 0775231 or a high melt flow rate polypropylene (1000 to 2000 g/10 min ate 230° C., 216 kg) such as disclosed in US 2008/0206583 or through the addition of volatile (e.g. petroleum ether) and/or non-volatile liquids (e.g. liquid paraffin) and/ or polymerizable monomers (e.g. stearyl methacrylate), such as disclosed in U.S. Pat. No. 6,287,706.

The addition of these viscosity reducing constituents results in less flexible layers with a pronounced tendency for curling especially those layers comprising a carrier mat. Because of this pronounced curling tendency, PVC-free decorative surface coverings comprising a reinforced layer obtained from calendering of reduced viscosity PVC-free pastes hardly can be stored and supplied in a rolled up form.

Moreover PVC-free decorative surface coverings comprising a reinforced layer obtained from calendering of reduced viscosity PVC-free pastes exhibit curling tendency when exposed to heat

The addition of viscosity reducing constituents also results in PVC-free decorative surface coverings showing insufficient indentation properties. In order to preserve good residual indentation performances, the use of hard polymers with high melt flow rate and/or tackifiers is proposed in US 2008/0206583. However the addition of said hard polymers and/or tackifiers to the PVC-free paste implies that flexibility of the product will be dramatically decreased. Consequently, these formulations are suitable only for the production of tiles or planks, and must be avoided for roll applications.

Furthermore the addition of viscosity reducing constituents results in a PVC-free paste that passes through the carrier mat upon calendering, thus staining the cylinders making upscaling unrealistic.

### AIMS OF THE INVENTION

The present invention aims to provide PVC-free decorative floor and wall coverings that do not present the drawbacks of the state of the art PVC-free surface coverings.

A further aim of the present invention is to provide a PVC-free paste formulation and a method for the transformation of said PVC-free paste formulation into PVC-free decorative surface coverings, more particularly PVC-free decorative surface coverings comprising a glass fiber mat or a non-woven reinforced layer, through the conventional melt mixing/calendering process.

### SUMMARY OF THE INVENTION

The present invention discloses a PVC-free decorative surface covering comprising a reinforced layer, said layer comprising a carrier impregnated with a PVC-free paste having a dynamic viscosity at 200° C. and at a shear rate of 100/s comprised between 500 and 10000 Pa·s, preferably between 800 and 7000 Pa·s, more preferably between 1000 and 2500 Pa·s, said paste comprising:
from 5 to 50% by weight, preferably from 10 to 40% by weight, more preferably from 15 to 30% by weight of a polyolefin blend, said polyolefins being characterized by a melt flow rate equal to or less than 15 g/10 minutes, preferably comprised between 1 and 10 g/10 minutes, more preferably comprised between 1 and 5 g/10 minutes, at 190° C. and 2.16 kg according to ASTM D1238,
from 45 to 90% by weight, preferably from 60 to 80% by weight of one or more fillers and
from 0.5 to 12% by weight, preferably from 1 and 10% by weight, more preferably from 3 to 7% by weight of one or more lubricants.

Preferred embodiments of the present invention disclose one or more of the following features:
the polyolefin blend of the PVC-free paste comprises:
   from 5 to 55% by weight, preferably from 10 to 50% by weight, more preferably from 15 to 45% by weight and most preferably from 20 to 40% by weight of an ethylene homo- or copolymer comprising alpha-olefins (A),
   from 5 to about 55% by weight, preferably from 10 to 50% by weight, more preferably from 15 to 45% by weight and most preferably from 20 to 40% by weight of a vinyl carboxylate and/or alkyl (meth)acrylate comprising ethylene copolymer (B),
   from 5 to 55% by weight, preferably from 10 to 50% by weight, more preferably from 15 to 45% by weight and most preferably from 20 to 40% by weight of a polyolefin elastomer (C),
   from 1 to 25% by weight, preferably from 3 to 20% by weight and most preferably from 5 to 15% by weight of a polar group comprising polyolefin (D);
the ethylene homo- or copolymer (A) is a very low density ethylene homo- or copolymer, comprising from 5 to 95% by weight of ethylene and from 5 to 95% by weight of one or more C3 to C20 alpha olefins, characterized by a density of less than 0.916 g/cm³ and a melt flow rate ranging from 0.5 to 15 g/10 min., preferably from 0.7 to 10 g/10 min. more preferably from 1.0 to 7 g/ 10 min., at 190° C. and 2.16 kg, according to ASTM D1238;
the vinyl carboxylate and/or alkyl (meth)acrylate comprising ethylene copolymer (B) comprises from 40 to 95% by weight of ethylene and from 60 to 5% by weight of at least one co-monomer selected from the group consisting of vinyl esters of saturated carboxylic acids wherein the acid moiety has up to 4 carbon atoms and C1-C20 alkyl (meth)acrylates, characterized by a melt flow rate ranging from 0.1 to 10 g/10 min., preferably from 0.5 to 8 g/10 min., and most preferably from 1.0 to 5 g/10 min at 190° C. and 2.16 kg, according to ASTM D1238;
the polyolefin elastomer (C) is a homopolymer of C2-C20 olefins, or a copolymer of ethylene with at least one C3-C20 alpha-olefin and/or C2-C20 acetylenically unsaturated monomer and/or C4-C18 diolefins, characterized by a melt flow rate ranging from 0.1 to 13 g/10 min., preferably from 0.5 to 8 g/10 min., and more preferably from 1.0 to 5 g/10 min at 190° C. and 2.16 kg, according to ASTM D1238;
the polar group comprising polyolefin (D) is an elastomeric copolymer of ethylene and one or more C4-C10 alpha-olefins comprising from 0.1 to 20% by weight, based on the weight of the polyolefin, of one or more polar groups selected from the group consisting of organic acid anhydrides and carboxylic acids and characterized by a melt flow rate ranging from 0.5 to 15 g/10 min., preferably from 0.7 to 10 g/10 min., more preferably from 1.0 to 8 g/ 10 min., at 190° C. and 2.16 kg, according to ASTM D1238;
the one or more lubricants of the PVC-free paste are selected from the group consisting of the stearic acid type, the fatty acid ester type, the fatty acid amide type, the paraffin hydrocarbon type, the metal soap type, the silicone type used alone or as a mixture;
the one or more fillers of the PVC-free paste are selected from the group consisting of talc, mica, calcium carbonate, magnesium carbonate or calcium-magnesium carbonate, barite, kaolin, silica, glass, or any combination thereof;
the carrier comprises a glass-fiber mat characterized by an air permeability greater than 3000 l/m²·s, preferably comprised between 3000 and 15000 l/m²·s, and preferably comprised between 3500 and 10000 l/m²·s;
the carrier comprises a non-woven characterized by an air permeability greater than 3000 l/m²·s, preferably comprised between 3000 and 15000 l/m²·s, and more preferably comprised between 3500 and 10000 l/m²·s.

The present invention further discloses a process for the preparation of said PVC-free decorative surface covering comprising the steps of:
a) supplying a carrier;
b) contacting the carrier of step a) with the PVC-free paste and impregnating said carrier using a calendering process to form a reinforced layer ;
c) cooling down the reinforced layer of step b).

Preferred embodiments of the process for the preparation of said PVC-free decorative surface covering disclose one or more of the following features:
the reinforced layer of step b) is contacted with one or more PVC-free pastes using a calendering process to form a laminated decorative surface covering;
the calendering of step b) is performed at an internal temperature comprised between 180 and 240° C., preferable between 190 and 230° C., more preferable between 200 and 220° C.;
the carrier is a glass-fiber mat characterized by an air permeability greater than 3000 l/m²·s, preferably comprised between 3000 and 15000 l/m²·s, and more preferably comprised between 3500 and 10000 l/m²·s;
the carrier is a non-woven characterized by an air permeability greater than 3000 l/m²·s, preferably comprised between 3000 and 15000 l/m²·s, and more preferably comprised between 3500 and 10000 l/m²·s;
the PVC-free paste is obtained from melt-mixing:
   from 5 to 50% by weight, preferably from 10 to 40% by weight, more preferably from 15 to 30% by weight of a PVC-free polymer blend, said polymer blend being characterized by a melt flow rate equal to or less than 15 g/10 min., preferably comprised between 1 and 10 g/10 min., more preferably comprised between 1 and 5 g/10 min., at 190° C. and 2.16 kg according to ASTM D1238,
   from 45 to 90% by weight, preferably from 60 to 80% by weight of one or more fillers and
   from 0.5 to 12% by weight, preferably from 1 and 10% by weight, more preferably from 3 to 7% by weight of one or more lubricants;
      at an internal temperature comprised between 180 and 240° C., preferably between 190 and 230° C., more preferably between 200 and 220° C.;
the set temperature of the calendering cylinders is comprised between 150 and 195° C., preferably between 160 and 190° C., more preferably between 165 and 185° C.

### DETAILED DESCRIPTION OF THE INVENTION

Decorative surfaces in many cases include a reinforced layer comprising an impregnated carrier such as an impregnated glass fiber mat.

During the production of PVC floor and wall coverings, the glass fiber mat typically is impregnated with a PVC plastisol. For this purpose, the PVC plastisol is usually applied to the glass fiber mat in a predetermined layer thickness or with a predetermined surface weight (e.g. approx. 400 g/m²). The PVC plastisol paste may be applied using conventional techniques e.g. spreading knife, roller coater, screen coaters, hot melt coaters and extrusion coaters.

The PVC plastisol in general comprises about 25% by weight of liquid constituents and is characterized by a Brookfield viscosity, at room temperature, in the range of about 1 Pa·s. Typically the plastisol comprises polyvinyl chloride, phthalate based and/or phthalate-free plasticizers, stabilizer, epoxidized vegetable oil and other components selected from the group consisting of viscosity reducers, blowing agents, liquid kickers, antistatic agents, fillers, fire retardants, dyes, pigments, lubricants and processing aids.

These plastisol easily diffuses into the glass fiber mat. Subsequently the liquid plastisol, saturating the glass mat, is fused and gelled by heating it during a period comprised between 5 and 60 seconds, preferably between 10 and 30 seconds at a temperature comprised between 130 and 150° C. for example by contacting it with hot cylinders.

Further layers then may be applied to the impregnated glass fiber mat; typically these include a foam core, a decorative layer, a clear protective wear layer. These additional layer(s) may be obtained from fusing and gelling of one or more plastisol layers, spread out on one or both sides of the reinforced PVC layer or through melt mixing and calendering one or more PVC formulations on at least on one side of the reinforced PVC layer.

Adhesion and cohesion between the different layers is obtained by heat treating the stack of layers for example during 2 minutes at 180° C. The usable side can then receive a final finishing, for example by means of a coating of clear varnish or other special coatings.

The calendering process is the most economic and efficient method for manufacturing traditional decorative surface coverings.

Yet, for the production of a reinforced layer, comprising a PVC impregnated glass-fiber mat, using the calendering process, major problems arise.

In addition to the requirement of a glass fiber mat with higher porosity, higher temperatures are needed for decreasing and adjusting the viscosity of the paste in order to have a sufficient impregnation into said glass fiber mat. On top of that, higher blending temperatures are required for obtaining an appropriate mixing of the paste constituents.

Where for the plastisol application a glass fiber mat with an air permeability comprised between 1000 and 4000 l/m²·s, preferably between 1500 and 3000 l/m²·s allows sufficient saturation, a glass fiber mat characterized by an air permeability of about 4000 l/m²·s is required in the calendering process.

Typically these higher viscosity pastes comprise about 15% by weight of liquid constituents and are characterized by a viscosity at 170° C. comprised between 500 and 1500 Pa·s.

The higher temperatures required for realizing an appropriate blending of the formulation and for calendering it on a glass fiber mat while having sufficient impregnation of said the glass fiber mat, result in a thermal degradation of said PVC formulation so that industrial processing is hardly feasible.

When PVC-free floorings, comprising a glass fiber mat reinforced layer, are considered, the viscosity problem is even more pronounced as the PVC-free polymers, included in the formulation, in general are characterized by a low melt flow index.

If a PVC-free paste is calendered, its poor processability in general is remedied through the addition of viscosity reducing compounds.

The addition of low molecular weight viscosity reducing constituents results in PVC-free decorative surface coverings with sufficient flexibility yet characterized by mediocre indentation properties.

In order to keep good indentation properties while reducing the viscosity of the PVC-free paste, low viscosity polymers and/or tackifiers, such as disclosed in US 2008/0206583, are added to the PVC-free formulation. The addition of these hard high melt flow rate polymers, such as high melt flow rate polypropylene, results in PVC-free decorative surface coverings having good indentation properties, yet insufficient flexibility with a pronounced tendency for curling especially when said decorative surface coverings comprise a carrier.

Furthermore it has also been observed that the introduction of significant levels (5 weight percentage or more on the total amount of polymers) of high melt flow rate polymers (MFR at 190° C., 2.16 kg equal to or greater than 50 g/10 min.) and/or tackifiers (1 weight percentage or more on the total amount of polymers) results in a PVC-free paste passing through the carrier mat. The paste passing through the carrier mat sticks to the opposite cylinders during extraction of the PVC-free layer comprising the carrier and/or during mechanical embossing of the laminate comprising the reinforced layer. This staining phenomenon occurring on the cylinders is unacceptable for further upscaling.

The present invention relates to a PVC-free decorative surface covering, in particular a floor or wall covering, comprising one or more layers, of which at least one layer is a reinforced layer comprising a PVC-free paste impregnated carrier, said decorative surface covering showing sufficient resistance to indentation and no or a negligible tendency to curling when produced in a conventional melt-mixing/calendering process. The present invention also relates to decorative surfaces that may show good flexibility, if required. The final product additionally may comprise a printed layer, a toplayer and a wear layer. The decorative surface coverings, according to the present invention, are thus especially suitable for flexible floor applications.

The PVC-free paste of the present invention comprises
from 5 to 50% by weight of a blend of polyolefins, said polyolefins being characterized by a melt flow rate at 190° C., 2.16 kg equal to or less than 15 g/10 minutes, preferably comprised between 1 and 10 g/10 minutes, more preferably comprised between 1 and 5 g/10 minutes,
from 45 to 90% by weight of one or more fillers and
from 0.5 to 12% by weight of lubricants.

The PVC-free paste is characterized by a dynamic viscosity at 200° C. and at a shear rate of 100/s comprised between 500 and 10000 Pa·s, preferably between 800 and 7000 Pa·s and more preferably between 1000 and 2500 Pa·s.

The higher viscosities, compared to the plastisol process, imply that said viscosities are measured using a rheometer, specifying the shear rate, taking the thickness and the relative speed of the cylinders into consideration. A typical shear rate is 100/s.

The polyolefin blend of the present invention comprises from 5 to 55% by weight of a polyethylene (A), from 5 to 55% by weight an ethylene copolymer (B) which comprises at least one co-monomer selected from the group consisting of vinyl esters of saturated carboxylic acids wherein the acid moiety has up to 4 carbon atoms, from 5 to 55% by weight of a polyolefin elastomer (C) and from 1 to 25% by weight of a polar group comprising polyolefin (D).

The polyethylene (A) suitable for the polyolefin blend of the present invention is selected from the group consisting of low density polyethylene (“LDPE”) also known as “branched” or “heterogeneously branched” polyethylene and “linear low density polyethylene” (“LLDPE”) both typically having a density in the range of 0.916-0.928 g/cm³, medium density polyethylene (“MDPE”) having a density typically in the range of 0.928 to 0.940 g/cm³, and very low density polyethylene (“VLDPE”) having a density less than 0.916 g/cm³, typically 0.890 to 0.915 g/cm³ or 0.900 to 0.915 g/cm³.

The polyethylene (A) preferably suitable for the polyolefin blend of the present invention is a very low density polyethylene, referring to a polyethylene homo- and copolymer having a density of less than 0.916 g/cm³. The co-monomers that are useful in general for making VLDPE copolymers include alpha-olefins, such as C3-C20 alpha-olefins and preferably C3-C12 alpha-olefins.

The alpha-olefin co-monomer can be linear or branched, and two or more co-monomers can be used. Examples of suitable co-monomers include linear C3-C12 alpha-olefins, and alpha-olefins having one or more C1-C3 alkyl branches, or an aryl group. Specific examples include propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene and styrene. Preferred co-monomers include propylene, 1-butene, 1-pentene, 4-methyl-1-pentene, 1-hexene, 1-octene and styrene, more preferably 1-butene, 1-hexene, and 1-octene.

The VLDPE polymer has a density of less than 0.916 g/cm³, and preferably at least 0.890 g/cm³, more preferably at least 0.900 g/cm³. Thus, a preferred density range for the VLDPE polymer is 0.900 g/cm³ to 0.915 g/cm³. Alternate lower limits of the VLDPE polymer density include 0.905 g/cm³ or 0.910 g/cm³.

The VLDPE polymer is further characterized by a melt flow rate ranging from 0.5 to 15 g/10 min. preferably from 0.7 to 10 g/10 min. more preferably from 1.0 to 7 g/10 min. at 190° C. and 2.16 kg according to ASTM D1238.

The VLDPE polymer is made in a conventional Ziegler-Natta polymerization process and preferably in a metallocene-catalyzed polymerization process.

Generally from about 5 to about 55% by weight, preferably from about 10 to about 50% by weight, more preferably from about 15 to 45% by weight and most preferably from about 20 to about 40% by weight of the ethylene-homo- or copolymer (A) is employed in the polymer blend of the present invention.

The ethylene copolymers (B) suitable for the polyolefin blend of the present invention are copolymers of ethylene with at least one co-monomer selected from the group consisting of vinyl esters of saturated carboxylic acids wherein the acid moiety has up to 4 carbon atoms and C1-C20 (meth)acrylates.

The ethylene content of the copolymer is 40 to 95% by weight, preferably 45 to 90% by weight, more preferably from 60% to 85% by weight.

The co-monomer preferably is vinyl acetate.

The melt flow rate (190° C., 2.16 kg) of the copolymer (B) ranges from 0.1 to 10 g/10 min., preferably from 0.5 to 8 g/10 min., and most preferably from 1.0 to 5 g/10 min.

Generally from about 5 to about 55% by weight, preferably from about 10 to about 50% by weight, more preferably from about 15 to about 45% by weight and most preferably from about 20 to about 40% by weight of ethylene copolymer (B) is employed in the polymer blend of the present invention.

The polyolefin elastomer (C) suitable for the composition of the present invention is a homopolymer of C2-C20 olefins, such as ethylene, propylene, 4-methyl-1-pentene, etc., or a copolymer of ethylene with at least one C3-C20 alpha-olefin and/or C2-C20 acetylenically unsaturated monomer and/or C4-C18 diolefins.

Monomers usefully polymerized according to the present invention include, for example, ethylenically unsaturated monomers, acetylenic compounds, conjugated or nonconjugated dienes, polyenes, carbon monoxide, etc.

Preferred monomers include the C2-C10 alpha.-olefins especially ethylene, propylene, isobutylene, 1-butene, 1-hexene, 4-methyl-1-pentene, and 1-octene. Other preferred monomers include styrene, halo-or alkyl substituted styrenes, tetrafluoroethylene, vinylbenzocyclobutane, 1,4-pentadiene, 2-methyl-1,4-pentadiene, 1,5-hexadiene, 1,4-hexadiene, 2-methyl-1,5-hexadiene, dicyclopentadiene, norbornadiene, methylenenorbornene and 1,5-cyclooctadiene, and naphthenics (e.g., cyclo-pentene, cyclo-hexene and cyclo-octene).

The polyolefin elastomer (C) preferably is an ethylene/alpha-olefin copolymer more preferably a copolymer of ethylene and 1-octene, of ethylene and 1-hexene, of ethylene and 1-pentene, of ethylene and 1-butene, of ethylene and propylene, wherein the ethylene content is comprised between 10 and 95% by weight, preferably between 15 and 90% by weight, more preferably between 20 and 85% by weight.

The polyolefin elastomer (C) is made in a conventional Ziegler-Natta polymerization process and preferably in a metallocene-catalyzed polymerization process.

The melt flow rate (190° C., 2.16 kg) of the polyolefin elastomer (C) ranges from 0.1 to 13 g/10 min., preferably from 0.5 to 8 g/10 min., and more preferably from 1.0 to 5 g/10 min..

Generally from about 5 to about 55% by weight, preferably from about 10 to about 50% by weight, more preferably from about 15 to about 45% by weight and most preferably from about 20 to about 40% by weight of the polyolefin elastomer (C) is employed in the polymer blend of the present invention.

The polar group comprising polyolefin (D) suitable for the polyolefin blend of the present invention is a polypropylene homopolymer, a polypropylene random copolymer, or a polypropylene ethylene copolymer, or an elastomeric copolymer, or a copolymer of ethylene and an alpha-olefin having C4-C10.

The polar group can be any polar group that can be used to functionalize the polyolefins. The polar group may be obtained, e.g., from unsaturated organic acid anhydrides such as maleic anhydride and/or unsaturated carboxylic acids such as for example (meth)acrylic acid.

The polar group-functionalized polyolefin may be produced, for example, using a radical initiator.

The polar group is present in an amount of from 0.1 to 20% by weight, preferably from 0.5 to 15% by weight, more preferably from 1 to 10% by weight based on the weight of the polyolefin.

The melt flow rate (190° C. and 2.16 kg) for the functionalized polyolefin (D) ranges from 0.5 to 15 g/10 min, preferably from 0.7 to 10 g/10 min. more preferably from 1.0 to 8 g/ 10 min. at 190° C. and 2.16 kg according to ASTM D1238.

Generally from about 1 to about 25% by weight, preferably from about 3 to about 20% by weight and most preferably from about 5 to about 15% by weight of the polar group comprising polyolefin (D) is employed in the polymer blend of the present invention.

In general the PVC-free paste of the present invention comprises between 5 and 50% by weight, preferably between 10 and 40% by weight, more preferably between 15 and 30% by weight of the polyolefin blend (A, B, C and D), based on the combined weight of the filler component, the PVC-free polymer blend and the lubricant(s).

The lubricants suitable for the composition of the present invention are of the stearic acid type, the fatty acid ester type, the fatty acid amide type, the paraffin hydrocarbon type, the naphtenic hydrocarbon type, the metal soap type, the silicone type used alone or as a mixture.

In general the PVC-free paste of the present invention comprises between 0.5 and 12% by weight, preferably between 1 and 10% by weight more preferably between 3 and 7% by weight of lubricant(s), based on the combined weight of the filler component, the polyolefin blend and the lubricant(s).

The fillers suitable for the composition of the present invention can be any conventional filler, especially those types traditionally used in surface coverings. The filler can be organic, inorganic, or a combination of both, such as with different morphologies. Examples include, but are not limited to, coal fly ash, carbonate salts such as magnesium carbonate, calcium carbonate and calcium-magnesium carbonate, barium sulfate, carbon black, metal oxides, inorganic material, natural material, alumina trihydrate, magnesium hydroxide, bauxite, talc, mica, barite, kaolin, silica, post-consumer glass, or post-industrial glass, synthetic and natural fiber, or any combination thereof. Preferably, the filler comprises talc, mica, calcium carbonate, barite, kaolin, silica, glass, or any combination thereof.

In general the PVC-free paste of the present invention comprises between 45 and 90% by weight, preferably between 60 and 80% by weight of filler, based on the combined weight of the filler component, the polyolefin blend and the lubricant(s).

The compositions according to the present invention can optionally contain one or more additives, such as, antimicrobial, biocides, pigments or colorants, modifying resins, cross-linking agents, antioxidants, foaming agents, tackifiers, dispersion agents and/or other conventional organic or inorganic additives commonly used in polyolefin or in other surface coverings, such as, but not limited to, UV-stabilizers, antistatic agents, thermal and light stabilizers, flame retardants, or any combination thereof.

Preferably, the composition includes at least one pigment, flame retardant, thermal stabilizer/antioxidant, light stabilizer, antistatic agent, or any combination thereof.

The PVC-free paste can be made by compounding the polyolefin blend, the filler(s), the lubricant(s) and the one or more additives in a suitable heated mixer, for example in a twin screw or a single screw extruder, a mixing bowl with heated jacket, a Banbury mixer, continuous mixer, a ribbon mixer or any combination thereof to form a blend.

The PVC-free paste is obtained from melt-mixing at an internal temperature comprised between 180 and 240° C., preferably between 190 and 230° C., more preferably between 200 and 220° C.

By internal temperature it is meant the real temperature of the PVC-free paste and not the set temperatures of the equipment for preparing and processing of said PVC-free paste.

The PVC-free paste is characterized by a viscosity at 200° C. and at a shear rate of 100/s comprised between 500 and 10000 Pa·s, preferably between 800 and 7000 Pa·s and more preferably between 1000 and 2500 Pa·s.

The uniform hot mass can then be discharged onto one or more processing machines, comprising a series of calender rolls. A series of calender rolls can be used to control the thickness and finish of a resulting sheet of the composition.

The set temperature of the calendering rolls is comprised between 150 and 190° C., preferably between 160 and 180° C.

The PVC-free paste of the present invention can be used as a stand-alone product, such as a PVC-free tile or sheet product or in rolls.

In another embodiment the PVC-free pastes of the present invention are used in a laminated decorative surface covering comprising for example a backing layer, preferably comprising the PVC-free paste of the present invention, wherein the backing layer has a top surface and a bottom surface; a decor layer, preferably comprising the PVC-free paste of the present invention, having a top surface and a bottom surface, wherein the bottom surface of the decor layer can be affixed to the top surface of the backing layer; at least one wear layer, preferably comprising the PVC-free paste of the present invention, having a top surface and a bottom surface, wherein the bottom surface of the wear layer can be affixed to the top surface of the decor layer and optionally one or more coating and/or printing layers.

The laminated decorative surface covering includes a reinforced layer, comprising a carrier, such as a glass mat and/or non-woven and the PVC-free paste of the present invention.

The reinforced layer can be in any order, thickness, and/or composition suitable for balancing the structure and performance of the surface covering.

We have surprisingly found that, contrary to high viscosity PVC pastes, the high viscosity PVC-free pastes of the present invention can be processed at temperatures above 170° C. on existing melt mixing/calendering equipment without any degradation or decomposition.

We have found that the PVC-free paste of the present invention, comprising less than 12% by weight of lubricant allows for a complete impregnation of a carrier characterized by an air permeability comprised between 3000 and 15000 l/m²·s, and preferably comprised between 3500 and 10000 l/m²·s, when produced by a conventional calendering process at an internal temperature of the PVC-free paste comprised between 180 and 240° C., preferably between 190 and 230° C., more preferably between 200 and 220° C.

Due to the shear forces, occurring at these process set temperatures, the PVC-free paste internal temperature is kept sufficiently high, so that the melt viscosity of the PVC-free paste, at these processing set temperatures, is comparable to the melt viscosity of PVC pastes measured at a temperature just below their decomposition temperature (170° C.), thus allowing full impregnation of the glass-fiber mat.

The decorative PVC-free surface coverings comprising the reinforced layer according to the present invention, and produced by a conventional melt-mixing/calendering process, prove to have sufficient resistance to indentation and no or a negligible tendency to curling when exposed to heat or after being stored and supplied in a rolled-up form.

### EXAMPLES

The following illustrative example is merely meant to exemplify the present invention but is not destined to limit or otherwise define the scope of the present invention.

A PVC-free paste formulation, according to the formulation as given in table 1, is prepared by melt-mixing wherein the internal temperature of said paste is about 200° C.

The set temperature of the cylinders is between 165 and 185° C. Because of the friction which occurs between the cylinders during calendering, the internal temperature of the PVC-free paste, between the cylinders, remains substantially equal to the internal temperature of the PVC-free paste obtained during the melt-mixing step.

In the present invention it has been surprisingly found that the high viscosity of the PVC-free paste according to the present invention, advantageously allows for a good processing on conventional melt-mixing/calendering equipment, contrary to what is disclosed in prior art. Indeed, this high viscosity during calendaring is very helpful for maintaining the (high) temperature of the PVC-free paste into the calender, thus guaranteeing a good homogeneity of said paste during the entire calendaring process.

For this case, the processability is very similar between material arriving into the calender cylinders just after being melt-mixed (=fresh material) and the other material that has not been past directly between the cylinders (=old material) been not directly be passed between the cylinders. The high viscosity combines advantages regarding processability and final properties.

TABLE 1

| | | MFR (190° C.; 2.16 kg) | % by |
|---|---|---|---|
| | Constituent | ASTM 1238 (g/10 min. | weight |
| Polymer (A) | Clearflex CLDO | 3.0 | 7.1 |
| Polymer (B) | Greenflex ML 50 | 1.7 | 7.1 |
| Elastomer (C) | Tafmer DF 710 | 1.0 | 7.1 |
| Polymer (D) | Fusabond 525 | 3.7 | 2.4 |
| Filler | Chalk Superfine | | 69.0 |
| | Zinc Oxide Neige A | | 2.0 |
| Lubricant | Paraffin | | 4.7 |
| Lubricant | Radiacid 0444 | | 0.5 |
| Antioxidants | Irganox 1010 | | 0.1 |

In table 1, Clearflex® CLDO is a very low density polyethylene, with a density of 0.900 g/cm³ from Polimeri; Greenflex® ML 50 is a copolymer of ethylene and vinyl acetate fromPolymeri Europa; Tafmer™ DF 710 is an ethylene-butene elastomer from Mitsui Company; Fusabond® 525 is a maleic anhydride modified ethylene copolymer from Dupont Company; Chalk Superfine is calcium carbonate from Omya; Zinc Oxide Neige A is Zinc oxide from Umicore; Paraffin is a mineral parrafinic process oil from Petrocenter; Radiacid® 0444 is a stearic acid from Oleon and Irganox® 1010 is a sterically hindered phenolic antioxidant from BASF.

The glass fiber mat was supplied by JohnsMainville (also called JS) under their designation SH 35/3 having an air permeability of 4500 l/m²·s; another glass fiber mat was supplied by Aldorfs under their designation AP 35 having an air permeability of 9500l/m²·s.

The Colback® non-woven comprising 15 Decitex coextruded polyester/polyamide fibers was supplied by Colbond having a weight of respectively 75, 50 and 30 g/m² and a corresponding air permeability of respectively 3700, 4700 and 7500l/m²·s

As the PVC-free paste has to diffuse through the carrier, the air permeability of said carrier has to meet a minimum value; the maximum value of air permeability is determined and limited by the mechanical resistance of said carrier which is decisive for avoiding cracks and fractures during the carrier lamination process.

The PVC-free paste of the composition as in table 1 has a dynamic viscosity at 200° C. and a shear rate of 100/s of 1500 Pa·s.

The different glass fiber mats and non-wovens then were impregnated with the PVC- free paste of table 1 using the calendering process wherein the temperature of the cylinders were respectively 170 and 175° C. A good adhesion of the PVC-free paste with the respective carrier was perceived.

The carrier comprising layer thus obtained, with an overall thickness of about 1.2 mm then was subjected to a second calendering step wherein a layer of about 0.5 mm of PVC-free paste of table 1 was applied on the remaining exposed side of the 1.2 mm carrier comprising layer. The reinforced layer thus obtained has an overall thickness of about 1.7 mm. The reinforced layer, comprising the impregnated carrier, was then transformed into a decorative surface covering through the application of a top layer.

Hereto a coextruded film of 250 μm of Surlyn® 9020, a zinc ionomer ethylene-(meth)acrylic acid-(meth)acrylate thermoplastic resin and 50 μm of Bynel 2022, an ethylene-(meth)acrylic acid-(meth)acrylate terpolymer, both form Dupont were coextruded forming a 300 μm top layer.

The 50 μm Bynel 2022 side of the coextrudate was then contacted with the 0.5 mm side of the reinforced layer, which was first heated to about 100° C. by means of infrared irradiation. The top layer was then pressed onto the reinforced layer and subsequently heated, for 2.5 minutes, in an oven at an ambient temperature comprised between 160 and 200° C. In an additional step the top layer, heated by infrared irradiation to a temperature comprised between 140 and 180° C., was mechanically embossed.

The decorative surface coverings, comprising a reinforced layer comprising a carrier impregnated with the PVC-free paste of table 1, and prepared by a calendering process, at 170 and 175° C°C., do not prove any curling after unrolling after being stored in a rolled up form.

The decorative surface coverings of the present invention further prove a curling according EN 14565 after exposure to heat (50° C., 6 hrs.) equal to or less than 2 mm and a residual indentation of less than 0,25 mm, as measured on a 0.25 cm² surface sample having a thickness of around 2 mm, submitted to a pressure of 500 N during 60 seconds. The residual indentation is measured 60 seconds after removal of the pressure.

1.A PVC-free decorative surface covering comprising
a reinforced layer, said layer comprising a carrier impregnated with a PVC-free paste having a dynamic viscosity at 200° C. and at a shear rate of 100/s comprised between 500 and 10000 Pa·s, said paste comprising:
from 5 to 50% by weight of a polyolefin blend, said polyolefins being characterized by a melt flow rate equal to or less than 15 g/10 minutes at 190° C. and 2.16 kg according to ASTM D1238,
from 45 to 90% by weight of one or more fillers and
from 0.5 to 12% by weight of one or more lubricants.

2. The PVC-free decorative surface covering according to claim 1, wherein the polyolefin blend comprises:
from 5 to 55% by weight of an ethylene homo- or copolymer comprising alpha-olefins (A),
from 5 to about 55% by weight of a vinyl carboxylate and/or alkyl (meth)acrylate comprising ethylene copolymer (B),
from 5 to 55% by weight of a polyolefin elastomer (C),
from 1 to 25% by weight of a polar group comprising polyolefin (D).

3. The PVC-free decorative surface covering according to claim 1, wherein the ethylene homo- or copolymer (A) is a very low density ethylene homo- or copolymer, comprising from 5 to 95% by weight of ethylene and from 5 to 95% by weight of one or more C3 to C20 alpha olefins, characterized by a density of less than 0.916 g/cm³ and a melt flow rate ranging from 0.5 to 15 g/10 min. at 190° C. and 2.16 kg, according to ASTM D1238.

4. The PVC-free decorative surface covering according to claim 1, wherein the vinyl carboxylate comprising ethylene copolymer (B) comprises from 40 to 95% by weight of ethylene and from 60 to 5% by weight of at least one co-monomer selected from the group consisting of vinyl esters of saturated carboxylic acids wherein the acid moiety has up to 4 carbon atoms and C1-C20 alkyl (meth)acrylates, characterized by a melt flow rate ranging from 0.1 to 10 g/10 min. at 190° C. and 2.16 kg, according to ASTM D1238.

5. The PVC-free decorative surface covering according to claim 1, wherein the polyolefin elastomer (C) is a homopolymer of C2-C20 olefins, or a copolymer of ethylene with at least one C3-C20 alpha-olefin and/or C2-C20 acetylenically unsaturated monomer and/or C4-C18 diolefins, characterized by a melt flow rate ranging from 0.1 to 13 g/10 min. at 190° C. and 2.16 kg, according to ASTM D1238.

6. The PVC-free decorative surface covering according to claim 1, wherein the polar group comprising polyolefin (D) is an elastomeric copolymer of ethylene and one or more C4-C10 alpha-olefins comprising from 0.1 to 20% by weight, based on the weight of the polyolefin, of one or more polar groups selected from the group consisting of organic acid anhydrides and carboxylic acids and characterized by a melt flow rate ranging from 0.5 to 15 g/10 min. at 190° C. and 2.16 kg, according to ASTM D1238.

7. The PVC-free decorative surface covering according to claim 1, wherein the one or more lubricants are selected from the group consisting of the stearic acid type, the fatty acid ester type, the fatty acid amide type, the paraffin hydrocarbon type, the naphtenic hydrocarbon type, the metal soap type, the silicone type used alone or as a mixture.

8. The PVC-free decorative surface covering according to claim 1, wherein the one or more fillers are selected from the group consisting of talc, mica, calcium carbonate, magnesium carbonate or calcium-magnesium carbonate, barite, kaolin, silica, glass, or any combination thereof

9. The PVC-free decorative surface covering according to claim 1, wherein the carrier comprises a glass-fiber mat characterized by an air permeability greater than 3000 l/m²·s.

10. The PVC-free decorative surface covering according to claim 1, wherein the carrier comprises a non-woven characterized by an air permeability greater than 3000 l/m²·s.

11. Process for the preparation of the PVC-free decorative surface covering according to claim 1, comprising the steps of:
a) supplying a carrier;
b) contacting the carrier of step a) with the PVC-free paste and impregnating said carrier using a calendering process to form a reinforced layer;
c) cooling down the reinforced layer of step b).

12. The process according to claim 11, comprising the additional step of contacting the reinforced layer of step b) with one or more PVC-free pastes using a calendering process to form a laminated decorative surface covering.

13. The process of claim 11, wherein the calendering of step b) is performed at an internal temperature of the blend comprised between 180 and 240° C.

14. The process according to claim 11, wherein the carrier is a glass-fiber mat characterized by an air permeability greater than 3000 l/m²·s, preferably comprised between 3000 and 15000 l/m²·s, and more preferably comprised between 3500 and 10000 l/m²·s.

15. The process according to claim 11, wherein the carrier is a non-woven characterized by an air permeability greater than 3000 l/m²·s, preferably comprised between 3000 and 15000 l/m²·s, and more preferably comprised between 3500 and 10000 l/m²·s.

16. The process according to claim 11, wherein the PVC-free paste is obtained from melt-mixing:
from 5 to 50% by weight of a PVC-free polymer blend, said polymer blend being characterized by a melt flow rate equal to or less than 15 g/10 min. at 190° C. and 2.16 kg according to ASTM D1238,
from 45 to 90% by weight of one or more fillers and
from 0.5 to 12% by weight of one or more lubricants;
at an internal temperature comprised between 180 and 240° C.

17. The process according to claim 11, wherein the set temperature of the calendering cylinders is comprised between 150 and 195° C.
